(19) United States
(12) Patent Application Publication
(10) Pub. No.: US 2026/0100619 A1
(43) Pub. Date: Apr. 9, 2026

(54) DRIVE UNIT OF ELECTRIC VEHICLE

(71) Applicants: TOYOTA JIDOSHA KABUSHIKI KAISHA, Toyota-shi (JP); AISIN CORPORATION, Kariya (JP)

(72) Inventors: Jumpei INOUE, Toyota-shi (JP); Hirokazu ARAI, Toyota-shi (JP); Atsushi KAWAMOTO, Toyota-shi (JP); Satoshi MIYANAGA, Kariya-shi (JP); Masaki YOSHIDA, Kariya-shi (JP); Yuki KOSAKA, Kariya-shi (JP); Takayori YAMAUCHI, Kariya-shi (JP)

(73) Assignees: TOYOTA JIDOSHA KABUSHIKI KAISHA, Toyota-shi (JP); AISIN CORPORATION, Kariya (JP)

(21) Appl. No.: 19/345,183

(22) Filed: Sep. 30, 2025

(30) Foreign Application Priority Data
Oct. 9, 2024 (JP) 2024-177214

(51) Int. Cl. H02K 5/22; B60L 15/00; H02K 7/00; H02K 11/33

(52) U.S. Cl. CPC H02K 5/225; B60L 15/007; H02K 7/006; H02K 11/33

(57) ABSTRACT

A drive unit of an electric vehicle in which a case holding a motor and a power control unit is downsized, and rigidity of the case is enhanced. In the drive unit, a motor, a power conversion equipment, and a terminal block are housed in a case. A cover is fixed to the case by bolts, and the terminal block is opposed to an inner surface of a portion of the case with which an outer edge of the cover is brought into contact. A service hole is formed on the case outside of the outer edge of the cover, and a flange is formed along the outer edge of the cover. The flange includes a marking surface on which model codes including a model code of the motor are marked.

### CROSS-REFERENCE TO RELATED APPLICATIONS

The present disclosure claims the benefit of Japanese Patent Application No. 2024-177214 filed on Oct. 9, 2024 with the Japanese Patent Office, the disclosures of which are incorporated herein by reference in its entirety.

### BACKGROUND

### Field of the Disclosure

The embodiment of the present disclosure relates to the art of a drive unit of an electric vehicle in which a motor serving as a prime mover and a power control unit for controlling the motor are housed in a case.

### Discussion of the Related Art

JP-A-2022-152851 describes an on-vehicle unit in which a transaxle case holding a motor therein, a power control unit for controlling the motor, and an electric unit including an electrical component are integrated together. In the on-vehicle unit described in JP-A-2022-152851, the electric unit is mounted on a mechanically and electrically integrated unit in which the power control unit is disposed on an upper surface of the transaxle case. The motor housed in the transaxle case is electrically connected with an inverter housed in a power control unit case through a bus-bar.

Thus, according to the teachings of JP-A-2022-152851, the motor housed in the transaxle case is connected with the inverter housed in the power control unit case through the bus-bar. In the case of housing the transaxle and the electrical component including the inverter together in the case, first of all, one of the transaxle and the inverter is connected with the bus-bar and lodged in the case. Thereafter, the other one of transaxle and the inverter is lodged in the case and connected with the bus-bar. To this end, it is necessary to ensure a working space for fixing the bus-bar to one of the transaxle and the inverter, and consequently the case is enlarged.

Given that service holes are formed in the case to remove the need for the working space, rigidity of the case decreases in the vicinity of the service holes. In this case, therefore, vibrations resulting from operating the power unit propagates to the case, and as a result, the case will be vibrated and a noise such as a radiated sound will be emitted.

### SUMMARY

Aspects of embodiments of the present disclosure have been conceived noting the foregoing technical problems, and it is therefore an object of the present disclosure to provide a drive unit of an electric vehicle in which a case holding a motor and a power control unit is downsized, and rigidity of the case is enhanced.

According to the exemplary embodiment the present disclosure, there is provided a drive unit an electric vehicle. In the drive unit, a motor that serves as a prime mover, a power conversion equipment that controls an electric power supplied to the motor, and a terminal block that is connected with the motor through first power cables and with the power conversion equipment through second power cables, are housed in a case. According to the exemplary embodiment the present disclosure, the drive unit is provided with a cover that is attached to a side wall of the case. Specifically, the cover is fixed to the side wall of the case by a plurality of bolts at its outer edge. The terminal block is placed to be opposed to an inner surface of a portion of the case with which the outer edge of the cover is brought into contact, and a service hole into which a tool for fixing the first power cables or the second power cables to the terminal block is inserted is formed on the side wall of the case outside the outer edge of the cover. In addition, a flange having a predetermined length in a direction along the outer edge of the cover is formed on the side wall of the case between the service hole and the outer edge of the cover or on the cover along the outer edge of the cover, and the flange includes a marking surface on which a model code including a model code of the motor is marked.

In a non-limiting embodiment, the terminal block and the power conversion equipment may be arranged above the motor in the vertical direction.

In a non-limiting embodiment, the power conversion equipment may be arranged parallel to the terminal block in the horizontal direction.

In a non-limiting embodiment, the case may include an opening that is closed by the cover, and the flange may be formed between the service hole and the opening.

Thus, according to the exemplary embodiment of the present disclosure, the motor and the power conversion equipment are housed in the case. Therefore, the drive unit formed of the motor and the power conversion equipment may be downsized. In the drive unit, the service hole is formed on the side wall of the case so that the tool for fixing the power cables to the terminal block may be inserted into the service hole, and the flange having a predetermined length in the direction along the service hole is formed on the case or the cover. Therefore, although the cover is fixed to the case by the bolts only at the sites around the terminal block, the rigidity of the portion of the cover between the bolts may be ensured. In the drive unit, vibrations resulting from the operation of the motor and the operation of the power conversion equipment propagate to the case. Nonetheless, the flange is formed in the vicinity of the service hole. According to the exemplary embodiment of the present disclosure, therefore, vibrations of the side wall of the case in the vicinity of the service hole may be reduced, and emission of radiated sound derived from the vibration of the case may also be reduced.

In addition, according to the exemplary embodiment of the present disclosure, the flange includes the marking surface on which model codes including a model code of the motor are marked. Therefore, it is not necessary to form a marking surface additionally on other portion of the case and the rear cover. That is, the flange serves not only as a reinforcement member to enhance the rigidity of the cover but also as the marking surface on which model codes and serial numbers are printed. According to the exemplary embodiment of the present disclosure therefore, the drive unit may be downsized.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a side view showing a structure of the drive unit according to the exemplary embodiment of the present disclosure;

FIG. 2 is a cross-sectional view showing a cross-section of the drive unit along the II-II line drawn in FIG. 1;

FIG. 3 is an enlarged partial view showing a service hole and a terminal block in a situation before a power conversion equipment and a rear cover are fixed to a case; and

FIG. 4 is a perspective view showing a structure of a flange.

### DETAILED DESCRIPTION OF THE PREFERRED EMBODIMENT(S)

An embodiment of the present disclosure will now be explained with reference to the accompanying drawings. Note that the embodiments shown below are merely examples of the present disclosure, and do not limit the present disclosure.

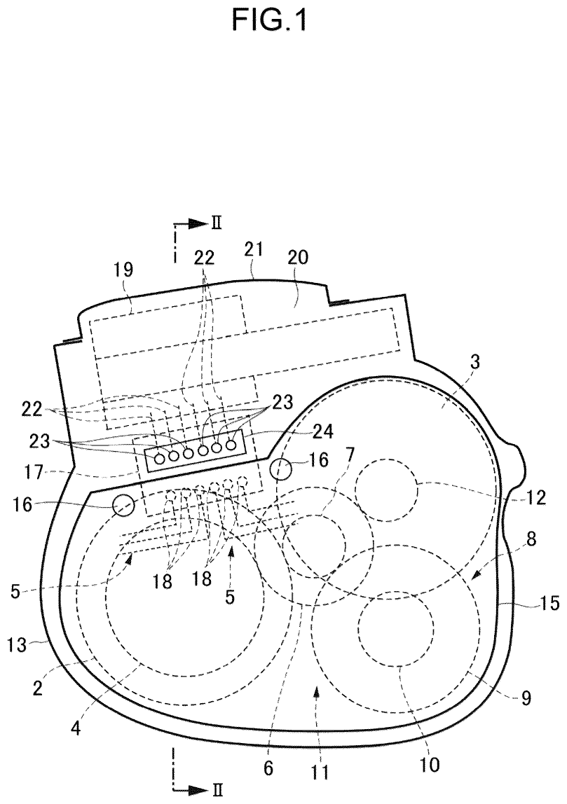

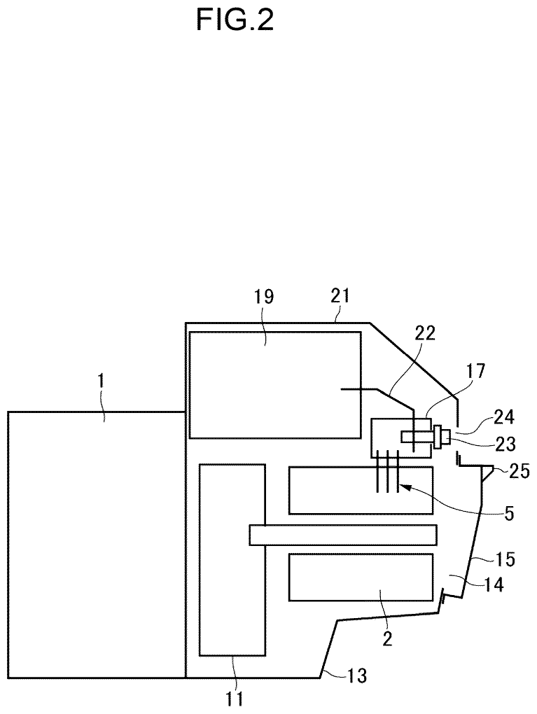

Referring now to FIG. 1, there is shown one example of a structure of a drive unit of an electric vehicle according to the exemplary embodiment of the present disclosure, and a cross-section of the drive unit along the II-II line drawn in FIG. 1 is shown in FIG. 2. The electric vehicle shown in FIGS. 1 and 2 is a hybrid vehicle in which a prime mover includes an engine 1 and motors 2 and 3. In the hybrid vehicle shown in FIGS. 1 and 2, a power generated by the prime mover is delivered to a pair of front wheels. To this end, the engine 1 and the motors 2 and 3 are arranged such that rotational center axes thereof extend in the width direction of the hybrid vehicle. Specifically, FIG. 1 is a side view showing the structure of the drive unit viewed from one of long sides of the hybrid vehicle. That is, the vertical direction in FIG. 1 corresponds to the vertical direction of the hybrid vehicle, and the left side in FIG. 1 corresponds to the front side of the hybrid vehicle.

As the motors employed in the conventional electric vehicles and hybrid vehicles, each of the motors 2 and 3 serves not only as a motor by supplying electric power thereto to generate a drive torque according to the supplied electric power, but also as a generator by passively rotating an output shaft thereof to translate a kinetic power rotating the output shaft at least partially into an electric power. For example, an AC motor such as a synchronous motor and an induction motor may be adopted as the motors 2 and 3.

According to the example shown in FIG. 1, the first motor 2 is placed at a lower vertical level in a front section of the drive unit, and an output shaft of the engine 1 and a power split mechanism (neither of which are shown) are arranged coaxially with a rotational center axis of the first motor 2. The power split mechanism is adapted to connect the engine 1, the first motor 2, and an output gear 4 in a differential manner. For example, a single-pinion planetary gear set may be adopted as the power split mechanism. In the power split mechanism, specifically, a carrier is connected to the engine 1, a sun gear is connected to the first motor 2, and a ring gear is connected to the output gear 4.

In the drive unit, therefore, torque generated by the engine 1 is partially delivered to the output gear 4 by establishing a reaction torque by the first motor 2 in accordance with the torque delivered to the power split mechanism from the engine 1. When the first motor 2 is establishing the reaction torque, the first motor 2 serves as either a motor or a generator, depending on a rotational direction thereof. For these purposes, in order to supply electric power to the first motor 2 and to output electric power generated by the first motor 2, first power cables 5 are connected with the first motor 2. In the example shown in FIG. 1, a three-phase AC motor is adopted as the first motor 2. Therefore, each of the first power cables 5 is connected with the respective one of the first phase (i.e., the U-phase), the second phase (i.e., the V-phase), and the third phase (i.e., the W-phase) of the first motor 2.

A countershaft (not shown) extends in parallel with the rotational center axis of the first motor 2. Specifically, the countershaft is situated higher than the rotational center axis of the first motor 2 in the vertical direction behind the first motor 2 in the longitudinal direction of the hybrid vehicle. A counter driven gear 6 is mounted on one end of the countershaft to be mated with the output gear 4, and a counter drive gear 7 which is diametrically smaller than the counter driven gear 6 is mounted on the other end of the countershaft.

A ring gear 9 of a differential gear unit 8 is mated with the counter drive gear 7, and both of driveshafts 10 are connected to the differential gear unit 8. It is to be noted that, in FIG. 2, the power split mechanism and the differential gear unit 8 are included in a transaxle 11 for the sake of illustration.

The second motor 3 is placed in parallel with the rotational center axis of the first motor 2 and a rotational center axis of the counter shaft. Specifically, the second motor 3 is placed higher than the rotational center axis of the countershaft behind the countershaft in the longitudinal direction of the hybrid vehicle. A drive gear 12 is mounted on an output shaft of the second motor 3 to be mated with the counter driven gear 6 so that an output torque of the second motor 3 may be added to the torque delivered from the engine 1 to the counter driven gear 6.

The second motor 3 serves as a motor when electric power generated by the first motor 2 is supplied thereto or when electric power is supplied thereto from a battery, and also serves as a generator when the second motor 3 applies a braking force to the hybrid vehicle. For these purposes, in order to supply electric power to the second motor 3 and to output electric power generated by the second motor 3, the first power cables 5 are also connected with the second motor 3. In the example shown in FIG. 1, a three-phase AC motor is also adopted as the second motor 3. Therefore, each of the first power cables 5 is also connected with the respective one of the first phase (i.e., the U-phase), the second phase (i.e., the V-phase), and the third phase (i.e., the W-phase) of the second motor 3.

The first motor 2, the second motor 3, and the transaxle 11 are housed in a case 13. In order to encase the first motor 2, the second motor 3, and the transaxle 11 in the case 13 and to fix these components in the case 13, an opening 14 is formed on one of side walls of the case 13 in the width direction. Specifically, an outline of the opening 14 is substantially congruent with outlines of the first motor 2, the second motor 3, and the transaxle 11 so that these components are allowed to be inserted into the case 13 through the opening 14.

After the first motor 2, the second motor 3, and the transaxle 11 are inserted into the case 13, the opening 14 is closed by a rear cover 15 serving as a cover of the exemplary embodiment of the present disclosure. An outside measurement of the rear cover 15 is larger than the opening 14 so that an outer edge of the rear cover 15 is fixed to the case 13 by a plurality of bolts 16. It is to be noted that, in FIG. 2, only two bolts 16 are illustrated for the sake of illustration.

A terminal block 17 is arranged above the first motor 2 in the vertical direction, and the first power cables 5 are connected with the terminal block 17. Specifically, the terminal block 17 is fixed to an inner wall of the case 13 slightly above the opening 14 to be oriented to the rear cover 15.

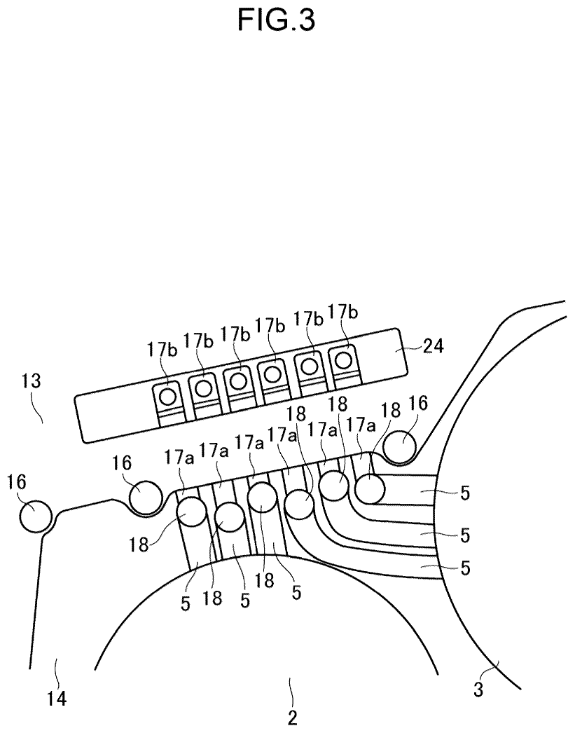

As illustrated in FIG. 3, the terminal block 17 comprises a plurality of lower terminals 17a. Specifically, six lower terminals 17a are arranged in juxtaposition along the side wall of the case 13. Each of the lower terminals 17a protrudes toward the opening 14, and the first power cables 5 are each fixed to the lower terminals 17a by bolts 18. It is to be noted that the first power cables 5 are fixed to the lower terminals 17a by the bolts 18 before closing the opening 14 by the rear cover 15.

A power conversion equipment 19 including an inverter is arranged parallel to the terminal block 17 in the horizontal direction. Specifically, the power conversion equipment 19 is arranged such that a part of a lower surface thereof is situated horizontally in parallel to the terminal block 17 while covering an upper end portion of the second motor 3. In order to insert the power conversion equipment 19 into the case 13, an opening 20 is formed on an upper end of the case 13. Therefore, the power conversion equipment 19 is inserted into the case 13 through the opening 20 and fixed to the case 13. After fixing the power conversion equipment 19 to the case 13, the opening 20 is closed by an upper cover 21.

As described, the power conversion equipment 19 includes the inverter that converts DC power supplied from a battery (not shown) into AC power to supply the AC power to the first motor 2 and the second motor 3, and converts AC powers generated by the first motor 2 and the second motor 3 into DC powers to supply the DC powers to the battery. The inverter of the power conversion equipment 19 is connected with the terminal block 17 through second power cables 22. Thus, six first power cables 5 and six second power cables 22 are connected with each other through the terminal block 17 so that the inverter is connected with the first motor 2 and the second motor 3.

As illustrated in FIG. 3, the terminal block 17 further comprises a plurality of upper terminals 17b. Specifically, six upper terminals 17b are also arranged in juxtaposition along the side wall of the case 13, and the second power cables 22 are each fixed to the upper terminals 17b by bolts 23. These bolts 23 are tightened by a tool such as a screw driver. For this purpose, a service hole 24 is formed on the side wall of the case 13, and the tool is inserted into the service hole 24 to tighten the bolts 23.

Specifically, the service hole 24 is a through hole having a predetermined length along a part of an outer edge of the opening 14 that is formed at a distance away from the opening 14. In other words, as illustrated in FIG. 1, the service hole 24 is formed outside the outer edge of the rear cover 15.

As illustrated in FIG. 3, the upper terminals 17b are oriented to the service hole 24, and the second power cables 22 are each fixed to the upper terminals 17b by bolts 23. After fixing the second power cables 22 to the upper terminals 17b, the service hole 24 is closed by a cover (not shown).

Thus, the upper terminals 17b are oriented to the service hole 24, and the lower terminals 17a are oriented to the opening 14. That is, the terminal block 17 is placed to be opposed to a portion of an inner surface of the case 13 between the service hole 24 and the opening 14. In other words, the terminal block 17 is placed to be opposed to the inner surface of a portion of the case 13 with which the outer edge of the rear cover 15 is brought into contact. Therefore, the rear cover 15 is fixed to the case 13 by the bolts 16 on both sides of the terminal block 17.

Therefore, it is not necessary to use bolts whose effective lengths are longer than a thickness of the case 13 to fix the rear cover 15 to the case 13, and in addition, leading ends of the bolts 16 will not come into contact with the terminal block 17. Further, it is not necessary to form projections on the inner surface of the case 13 which might come into contact with the terminal block 17 to ensure effective lengths of male screw.

Since the service hole 24 is formed on the side wall of the case 13, the portion of the side wall of the case 13 between the opening 14 and the service hole 24 is narrowed, and hence the rigidity of the case 13 at this portion is low. Therefore, the rear cover 15 may not be fixed by the bolts 16 to the portion of the side wall of the case 13 at which the rigidity thereof is low. For this reason, as shown in FIG. 2, a flange 25 is formed on the rear cover 15 along the outer edge of the rear cover 15 so as to enhance the rigidity of the rear cover 15.

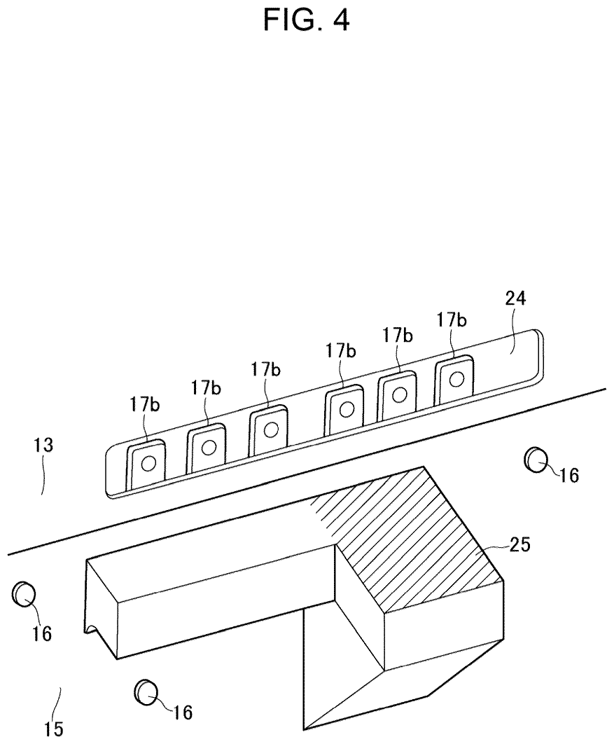

A structure of the flange 25 is shown in FIG. 4 in more detail. As illustrated in FIG. 4, the flange 25 has an L-shape viewed from above. Specifically, the flange 25 is formed along the outer edge of the rear cover 15 within a region between a site in front of a front end of the service hole 24 in the longitudinal direction of the hybrid vehicle and a site below an intermediate section of the service hole 24. In addition, a width of the flange 25 in the front section of the hybrid vehicle is narrower, and a width of the flange 25 in the rear section of the hybrid vehicle is wider. An upper surface of the flange 25 is shaped into a flat surface, and model codes of the first motor 2, the second motor 3, the drive unit etc. may be marked on the hatched area of the upper surface of the flange 25 in FIG. 4. That is, the upper surface of the flange 25 serves as a marking surface on which the model codes (or serial numbers) are marked. The above-mentioned model codes or serial numbers may be printed on the marking surface by appropriate means. For example, the model codes or serial numbers may be printed on the marking surface by applying a sticker indicating the model codes or serial numbers to the marking surface, or by stamping the model codes or serial numbers onto the marking surface. As illustrated in FIG. 4, the rear cover 15 may be fixed to the case 13 additionally by the bolt 16 at a site below the flange 25 where the terminal block 17 is not fixed to the inner wall of the case 13.

Thus, according to the exemplary embodiment of the present disclosure, the first motor 2, the second motor 3, the transaxle 11, and the power conversion equipment 19 are housed together in the case 13. Therefore, the drive unit formed of the first motor 2, the second motor 3, the transaxle 11, and the power conversion equipment 19 may be downsized. In the drive unit, the service hole 24 is formed on the side wall of the case 13 so that the tool may be inserted into the service hole 24 to fix the second power cables 22 to the upper terminals 17b. In addition, the flange 25 having a predetermined length in the direction along the service hole 24 is formed on the rear cover 15. Therefore, although the rear cover 15 is fixed to the case 13 by the bolts 16 only at the sites around the terminal block 17, the rigidity of the portion of the rear cover 15 between the bolts 16 may be ensured. In the drive unit, vibrations resulting from the operations of the first motor 2 and the second motor 3, the power transmission through the transaxle 11, and the operation of the power conversion equipment 19 propagate to the case 13. Nonetheless, the flange 25 is formed on the rear cover 15 in the vicinity of the service hole 24. Therefore, the vibrations of the side wall of the case 13 in the vicinity of the service hole 24 may be reduced, and emission of radiated sound derived from the vibration of the case 13 may also be reduced.

In addition, in the drive unit according to the exemplary embodiment of the present disclosure, model codes and serial numbers may be printed on the upper surface upper surface of the flange 25. That is, it is not necessary to form a marking surface additionally on other portion of the case 13 or the rear cover 15. Thus, the flange 25 serves not only as a reinforcement member to enhance the rigidity of the rear cover 15 but also as a marking surface on which model codes and serial numbers are printed. According to the exemplary embodiment of the present disclosure therefore, the drive unit may be downsized.

Although the above exemplary embodiments of the present disclosure have been described, it will be understood by those skilled in the art that the present disclosure should not be limited to the described exemplary embodiments, and various changes and modifications can be made within the scope of the present disclosure. For example, the flange 25 may also be formed on a site other than the rear cover 15 to prevent deformation of the portion in the vicinity of the service hole 24 where the rigidity thereof in low. Specifically, the flange 25 may also be formed on the side wall of the case 13 between the service hole 24 and the opening 14 to enhance the rigidity of the portion of the case 13 between the service hole 24 and the opening 14. In this case, a cut-out may be formed along the outline of the flange 25 to attach the rear cover 15 to the case 13.

In addition, the drive unit according to the exemplary embodiment of the present disclosure may also be applied to a series hybrid vehicle in which an engine is driven only to operate a generator, a parallel hybrid vehicle having only one motor to change a torque delivered from an engine to drive wheels, and an electric vehicle that is propelled only by a motor.

Further, the drive unit according to the exemplary embodiment of the present disclosure may be formed by housing at least the motor and the power conversion equipment 19 in the case 13. Therefore, the transaxle 11 and other components may also be held in another case.

What is claimed is:

1. A drive unit of an electric vehicle in which a motor that serves as a prime mover, a power conversion equipment that controls an electric power supplied to the motor, and a terminal block that is connected with the motor through first power cables and with the power conversion equipment through second power cables, are housed in a case, comprising
a cover that is attached to a side wall of the case,
wherein the cover is fixed to the side wall of the case by a plurality of bolts at its outer edge,
the terminal block is placed to be opposed to an inner surface of a portion of the case with which the outer edge of the cover is brought into contact,
a service hole into which a tool for fixing the first power cables or the second power cables to the terminal block is inserted is formed on the side wall of the case outside the outer edge of the cover,
a flange having a predetermined length in a direction along the outer edge of the cover is formed on the side wall of the case between the service hole and the outer edge of the cover, or on the cover along the outer edge of the cover, and
the flange includes a marking surface on which a model code including a model code of the motor is marked.

2. The drive unit of the electric vehicle as claimed in claim 1, wherein the terminal block and the power conversion equipment are arranged above the motor in a vertical direction.

3. The drive unit of the electric vehicle as claimed in claim 1, wherein the power conversion equipment is arranged parallel to the terminal block in a horizontal direction.

4. The drive unit of the electric vehicle as claimed in claim 1,
wherein the case includes an opening that is closed by the cover, and
the flange is formed between the service hole and the opening.

5. The drive unit of the electric vehicle as claimed in claim 2,
wherein the case includes an opening that is closed by the cover, and
the flange is formed between the service hole and the opening.

6. The drive unit of the electric vehicle as claimed in claim 3,
wherein the case includes an opening that is closed by the cover, and
the flange is formed between the service hole and the opening.
